(19) United States
(12) Patent Application Publication
(10) Pub. No.: US 2017/0269015 A1
(43) Pub. Date: Sep. 21, 2017

(54) METHOD FOR PREDICTING A MEASURED VALUE, AND CONDUCTIVITY SENSOR FOR EXECUTING THE METHOD

(71) Applicant: Endress+Hauser Conducta GmbH+Co. KG, Gerlingen (DE)

(72) Inventors: HERMANN GÜNTHER, Dresden (DE); Ronny Grosse-Uhlmann, Leisnig (DE)

(21) Appl. No.: 15/455,320

(22) Filed: Mar. 10, 2017

(30) Foreign Application Priority Data
Mar. 16, 2016 (DE) 10 2016 104 922.0

(51) Int. Cl. G01N 27/04

(52) U.S. Cl. CPC G01N 27/046

(57) ABSTRACT

The present disclosure relates to a method for predicting a measured value of a measured variable of a sensor of process automation technology, includes the steps of capturing a first measured value at a first point in time; capturing a second measured value at a second, later point in time, formation of a differential value between the second and first measured values, filtering out the differential value using a filter with an infinite impulse response, and calculating a future measured value using the measured value at the second point in time, the filtered differential value, and a constant that characterizes the sensor. The present disclosure further relates to a conductivity sensor including a temperature sensor and a computer unit for executing a method.

### CROSS-REFERENCE TO RELATED APPLICATION

The present application is related to and claims the priority benefit of German Patent Application No. 10 2016 104 922.0, filed on Mar. 16, 2016, the entire contents of which are incorporated herein by reference.

### TECHNICAL FIELD

The present disclosure relates to a method for predicting a measured value of a measured variable of a sensor in process automation technology, and a conductivity sensor for executing the method.

### BACKGROUND

In the field of metrology, it is desirable to obtain a measured value as fast as possible. This will be explained below using an example of temperature measurement. For a hygienic design or to protect the sensor from external influences in particular, to protect the interior of the sensor from harmful or poisonous properties or those that are otherwise disadvantageous to the sensor, the actual measuring element of the sensor is protected in a housing. However, this housing functions as a thermal insulator. The response time of the sensor is therefore increased, since a change in temperature of the medium to be measured is transmitted via the housing to the sensor or the sensor element. In many measuring strategies, such as conductivity measurement, temperature measurement is an auxiliary variable and a necessary prerequisite for determining the main parameter, such as the conductivity.

U.S. Pat. No. 8,301,408 discloses a sensor and a method for determining an estimated measured variable in real time. This document discloses the use of a filter with an infinite impulse response (IIR, infinite impulse response filter). This document discloses the determination of the onset of the measured variable in real-time.

### SUMMARY

The object of the present disclosure is to present a method that is robust and simply designed on the one hand, but also takes into account specific properties of the sensor on the other hand.

The object is achieved by a method comprising the steps of capturing a first measured value at a first point in time, capturing a second measured value at a second, later point in time, forming a differential value between the second and first measured values, filtering out the differential value using a filter with an infinite impulse response, and calculating a future measured value using the measured value at the second point in time, the filtered differential value, and a constant which characterizes the sensor.

In at least one embodiment, the measured value is the temperature.

By using the aforementioned method, the physically determined, slow response time is shortened. This increases the precision in dynamic processes, especially in measuring methods or characteristic curves with a high dependence on temperature. A good example of this are phase separation processes that occur before and after cleaning processes in the food industry. Due to the greater precision, the discarding of product that fills the leads after a cleaning process can be reduced.

In another embodiment, the sensor includes a computer unit, and the constant which characterizes the sensor uses the processor performance, memory, cycle time, and/or design. Accordingly, the properties of the sensor are included in the cited method, and the measured value is calculated beforehand using sensor-specific properties.

In an embodiment, the constant characterizing the sensor is determined under laboratory conditions before using the sensor and is permanently saved in the sensor. The sensor manufacturer can therefore determine the proper constant for the sensor, and the user does not have to repeat the determination. In a first variant, the constant is the same for each sensor type, i.e., for each pH or conductivity sensor, for example. In a second variant, the constant is individually ascertained for each sensor and correspondingly saved. Laboratory or standard conditions according to this present disclosure are constant temperature, constant air pressure, a well-defined amount of medium, and regular agitation of the medium. Typical values in this regard are room temperature (22° C.), normal air pressure (1020 hPa), and a medium volume of about 20 L.

In a further embodiment, a minimum differential value is used when the difference between the second and first measured values falls below a lower threshold, and a maximum differential value is used when the difference between the second and first measured values exceeds an upper threshold. Accordingly, the prediction of the measured value can be rendered even more precise, since a minimum or maximum differential value that is too low or too high would distort the calculation.

In an embodiment, the sensor is designed as a recursive system, and a result of filtering a previous measured value and the differential value between the measured values are fed to the filter with the infinite impulse response.

Particularly, in at least one embodiment, the filter is calculated by means of:

$${δ}_{f} ( i ) = \frac{d - 1}{d} \cdot {δ}_{f} ( i - 1 ) + \frac{1}{d} \cdot {δ}_{c} ( i )$$

where δ_{f}(i) being the filtered differential value at time i, d being the filter depth, and δ_{c} being the differential value between the measured values.

In a further embodiment, the future value is calculated from the sum of the measured value at the second point in time and the product of the filtered differential value and a constant that characterizes the sensor.

In certain embodiments, the method further includes the step of filtering the future measured value by means of a second filter to smooth a signal characteristic.

In an embodiment, the filter is not an IIR filter. An IR filter can alternatively be used.

The object is further achieved by a conductivity sensor including a temperature sensor and a computer unit for executing an aforementioned method.

### BRIEF DESCRIPTION OF THE DRAWINGS

The present disclosure is explained in greater detail with reference to the following figures. Illustrated are:

FIG. 1 shows the conductivity sensor according to the present disclosure; and

FIG. 2 shows a schematic diagram of the method according to the present disclosure.

### DETAILED DESCRIPTION

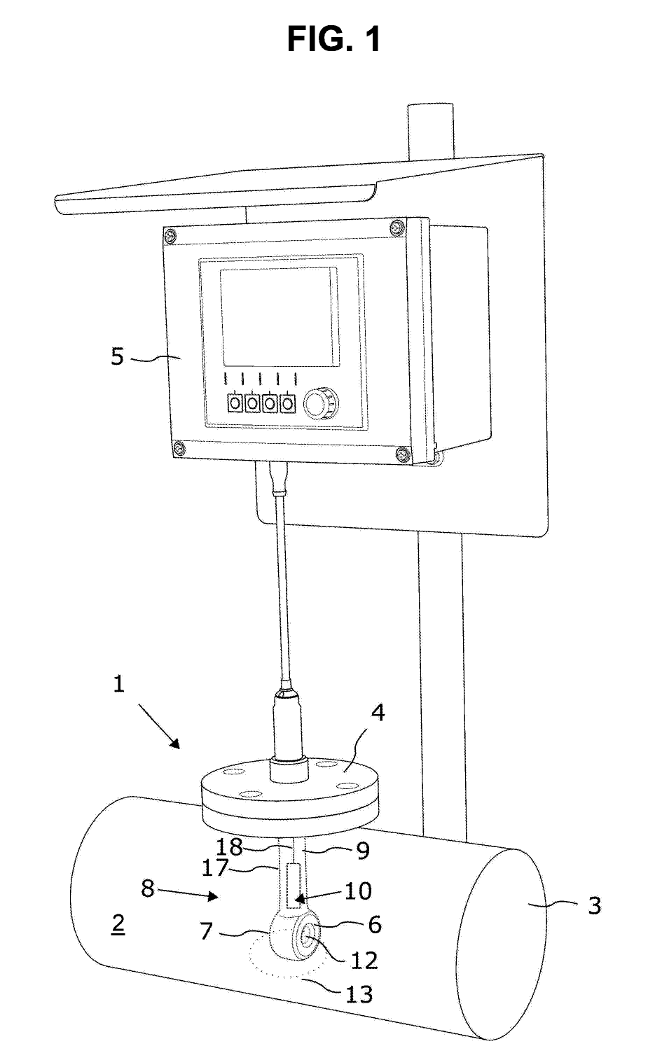

The entirety of the inductive conductivity sensor according to the present disclosure is marked with the reference symbol 1 and is shown in FIG. 1. The conductivity sensor 1 is designed for use in process automation.

The conductivity sensor 1 is arranged for example, via a flange 4 (i.e., a process connection) on a vessel 3 in which a medium 2 to be measured is located. The vessel 3 may be a pipe made, for example, of plastic or metal.

The conductivity sensor 1 includes a transmitter coil 6 and a receiver coil 7 that are located inside a housing 9. The housing 9 comprises a housing wall 17. The housing 9 is manufactured from a plastic, for example a thermoplastic, that is approved for use in the area of food technology and biotechnology. For example, this plastic is a polyaryl ether ketone, such as polyetheretherketone (PEEK). This will be discussed in more detail below.

The transmitter coil 6 and the receiver coil 7 are arranged, for example, opposite one another on sides of a circuit board (not shown) that face away from one another. In this way, the transmitter coil 6 and receiver coil 7, which are designed as rotation-symmetric toroidal coils (“toroids”), are arranged coaxially, one behind the other. The circuit board comprises the conductor paths that contact the coils and connect the transmitter coil 6 with a driver circuit, and the receiver coil 7 with a receiver circuit. The driver circuit and the receiver circuit can form part of the sensor circuit installed on the circuit board. The coils 6, 7 are connected with a data processing unit 5 in FIG. 1, with a measuring transducer. The data processing unit 5 is generally a computer unit. Some of the functions of the data processing unit 5 can also be directly performed in the sensor, which, for its part, includes a corresponding data processing unit.

The housing 9 forms a channel 12 that passes through the transmitter coil 6 and the receiver coil 7 along their axes of rotation. If the housing 9 is immersed in an electrically conductive medium 2, the medium 2 surrounds the housing 9, or at least a housing section 8 designed to be immersed in the medium 2, and enters the channel 12, so that in the medium 2 a closed current path 13 passing through both coils 6, 7 can form when the transmitter coil 6 is excited or flowed through by an input signal, e.g., an alternating voltage.

The conductivity sensor 1 functions in the manner of a double transformer, wherein the transmitter and the receiver coils 6, 7 are inserted as mentioned into the medium 2 to at least the extent that a closed current path 13 running through the medium 2 and passing through the transmitter and the receiver coils 6, 7 can be formed. When the transmitter coil 6 is excited with an alternating voltage signal used as an input signal, it generates a magnetic field which induces a current path 13 which passes through the coils 6, 7, the strength of which depends upon the electrical conductivity of the medium 2. Thus, a current path with an ionic conduction results in the medium 2. Since this alternating electrical current in the medium 2 in turn generates a varying magnetic field that surrounds it, an alternating current is induced in the receiver coil 7 as an output signal. This alternating current and the corresponding alternating voltage respectively, which are delivered by the receiver coil 7 as output signal, are a measure of the electrical conductivity of the medium 2.

The conductivity sensor 1 includes a temperature sensor 10 for measuring the temperature of the medium 2. The data processing unit 5 determines the conductivity of the medium 2 based upon the input signal, the output signal, and the temperature of the medium 2. The temperature sensor 10 is an electrical or electronic component that supplies an electrical signal as a measure of the temperature. The temperature sensor 10 is, for example, a negative temperature coefficient thermistor (NTC thermistor) or a positive temperature coefficient thermistor (PTC thermistor), the resistance of which changes with the temperature. Examples in this regard are platinum measuring resistors or ceramic PTC thermistors. Alternatively, the temperature sensor 10 may be used that directly supplies a processable electrical signal, such as, for example, a semiconductor temperature sensor that supplies a current or voltage proportional to the temperature. As additional alternatives, a thermocouple or other common temperature measuring element may be used.

The temperature sensor 10 includes a temperature element that supplies an electrical signal as a measure of the temperature. This is, for example, a thermistor, such as a Pt100 or Pt1000. Via wires 18, this signal such as, for example, resistance values or a voltage is transmitted to the measuring transducer 5.

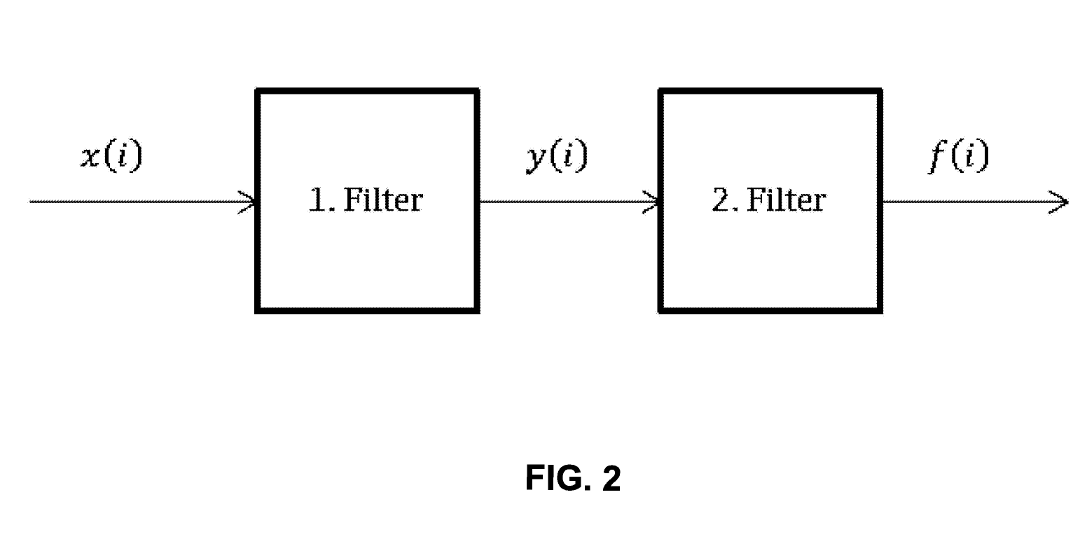

The method according to the present disclosure (see FIG. 2) for calculating a future measured value includes at least two steps, wherein a first filter is used for prediction, from which a prediction value y(i) is determined from a measured value x(i), and then smoothing is applied by means of a second filter. The temperature value f(i) is output. The second filter is not absolutely necessary and serves to smooth the signal. The method is carried out in a measuring transducer, or entirely or partially in a corresponding computer unit in the sensor.

First, a difference δ(i) between the current measured value (input value x(i)) and the last measured value x(i−1) is determined, with i as the respective point in time:

δ(i)=x(i)−x(i−1) EQN. 1

Outliers from this difference are “cut out” to prevent large jumps, as follows:

$${δ}_{c} ( i ) = \{ \begin{matrix}{δ}_{min} & if & δ ( i ) < {δ}_{min} \\ δ ( i ) & if & {δ}_{min} \leq δ ( i ) \leq {δ}_{max} \\ {δ}_{max} & if & δ ( i ) > {δ}_{max}\end{matrix} \qquad EQN . 2$$

The differential δ_{c}(i) value determined in this manner is fed to a simple IIR filter (infinite impulse response filter) with depth d:

$${δ}_{f} ( i ) = \frac{d - 1}{d} \cdot {δ}_{f} ( i - 1 ) + \frac{1}{d} \cdot {δ}_{c} ( i ) \qquad EQN . 3$$

The prediction value y(i) is calculated from the current measured value x(i), the output value of the filter δ_{f}(i), and the constant τ:

y(i)=x(i)+δ_{f}(i)·τ EQN. 4

The constant “τ” may be specific to each sensor type; for example, conductivity sensors have a value of η1, and pH sensors have a value of η2. The constant is accordingly a processor performance, memory, cycle time, and/or design, for example.

This constant is determined beforehand in the laboratory by means of tests. The constant is varied for the respective sensor type until the best value is determined, and a precise and sufficient prediction of the measured value, i.e., the temperature, can be made. Then, this value is permanently saved in the sensor. The user has no access to the value and is also unable to change it.

1. A method for predicting a measured value of a measured variable of a sensor of process automation technology, comprising the steps:
capturing a first measured value from a process automation sensor at a first point in time;
capturing a second measured value from the sensor at a later point in time;
determining a differential value between the second and first measured values;
filtering the differential value using a filter with an infinite impulse response to generate a filtered differential value; and
calculating a future measured value using the second measured value, the filtered differential value, and a sensor constant of the sensor.

2. The method of claim 1, wherein the first, second and future measured values are temperatures.

3. The method of claim 1, wherein the sensor includes a computer unit, and the sensor constant includes the processor performance, memory, cycle time, and/or design.

4. The method of claim 1, wherein the sensor constant is determined under laboratory conditions before using the sensor and is permanently saved in the sensor.

5. The method of claim 1, wherein the differential value is a minimum differential value when the difference between the second and first measured values is below a lower threshold, and wherein the differential value is a maximum differential value when the difference between the second and first measured values exceeds an upper threshold.

6. The method of claim 1, wherein the sensor is operable as a recursive system, and wherein a previous filtered differential value and the differential value between the first and second measured values are inputs to the filter with the infinite impulse response.

7. The method of claim 6, wherein the filter is calculated by means of:
$${δ}_{f} ( i ) = \frac{d - 1}{d} \cdot {δ}_{f} ( i - 1 ) + \frac{1}{d} \cdot {δ}_{c} ( i )$$
with δ_{f}(i) being the filtered differential value at time i,
d being a filter depth, and
δ_{c} being the differential value between the first and second measured values.

8. The method of claim 6, wherein the future measured value is calculated from a sum of the second measured value and a product of the filtered differential value and the sensor constant.

9. The method of claim 8, the method further comprising the step of filtering the future measured value using a second filter to smooth the signal characteristic.

10. The method of claim 9, wherein the second filter is not an infinite impulse response filter.

11. A conductivity sensor system comprising a conductivity sensor, a temperature sensor, and a computer unit, the computer unit configured to:
capture a first measured value from the conductivity sensor at a first point in time;
capture a second measured value from the conductivity sensor at a later point in time;
determine a differential value between the second and first measured values;
filter the differential value using a filter with an infinite impulse response to generate a filtered differential value; and
calculate a future measured value using the second measured value, the filtered differential value, and a sensor constant of the conductivity sensor.

12. The conductivity sensor system of claim 11, wherein the conductivity sensor is operable as a recursive system, and wherein a previous filtered differential value and the differential value between the first and second measured values are inputs to the filter with the infinite impulse response.

13. The conductivity sensor system of claim 12, wherein the filter is calculated by means of
$${δ}_{f} ( i ) = \frac{d - 1}{d} \cdot {δ}_{f} ( i - 1 ) + \frac{1}{d} \cdot {δ}_{c} ( i )$$
with δ_{f}(i) being the filtered differential value at time i,
d being a filter depth, and
δ_{c} being the differential value between the first and second measured values.

14. The conductivity sensor system of claim 12, wherein a future measured value is calculated from a sum of the second measured value and a product of the filtered differential value and the sensor constant.
